(19) United States
(12) Patent Application Publication
(10) Pub. No.: US 2003/0055979 A1
(43) Pub. Date: Mar. 20, 2003

(54) Internet domain name resolver

(76) Inventor: William Ray Cooley, Tulsa, OK (US)

Correspondence Address: DIGIMARC CORPORATION, 19801 SW 72ND AVENUE, SUITE 100, TUALATIN, OR, 97062, US

(21) Appl. No.: 09/957,672

(22) Filed: Sep. 19, 2001

(51) Int. Cl. G06F 15/16

(52) U.S. Cl. 709/227; 709/224

(57) ABSTRACT

The disclosure discloses a method for connecting a remote user to a destination host site having a Uniform Resource Locator (URL) including an Internet domain name and one or more Internet Protocol (IP) addresses. This method intercepts a locator request generated by a remote end user for the domain name of a destination host site, requests all available IP addresses for that site, determines the IP address with the fastest response, and returns the this address to the end user.

### TECHNICAL FIELD

The invention generally relates to communications between computers over the Internet and, more specifically, relates to improving communication between computers using the Domain Name System.

### BACKGROUND AND SUMMARY

Every host and router on the Internet has an Internet Protocol (IP) address. The Domain Name System (DNS) is often used to map host names to these IP addresses. For example, a client application typically sends a DNS query to a DNS server, which includes a host name and an indication that an IP address is requested. The DNS server then returns an IP address associated with the host name to the client application. The user may then request a web page from the server at the IP address provided. However, since the client application only has one IP address, it may only access the requested web page if the server at the IP address provided is available at that time. If the server at the IP address provided is unavailable, the user's request may trigger an error message and/or subject the user to other delays.

In many cases, a Domain Name System (DNS) host name is associated with several servers, each having a unique IP address and capable of responding to TCP connect requests. Despite the availability of these servers, it is not uncommon for a user to wait a long time to receive a web page, or worse, receive an error message, even though another server is available to provide the requested web page.

The invention provides a method of Internet domain name resolution. This method is implemented in name resolver software that intercepts a request to map a domain name to an IP address, and then retrieves the available IP addresses associated with the domain name from a DNS server. The name resolver determines which of the available IP addresses provides a fastest response time, and provides the IP address with the fastest response time for use in establishing a TCP/IP connection. In some implementations, a first program is used to retrieve the available IP addresses for a domain name, and a second program determines which of the available IP addresses provides the fastest response time. For example, a DNS server or web re-direction server provides the available IP addresses, and a client program, such as a browser, reader application or operating system, checks which IP address provides the fastest response. In short, the name resolver software can be distributed in different software modules on separate networked devices.

The name resolver may be implemented in an environment where it preemptively obtains the IP addresses with the fastest response times for a set of Uniform Resource Locators. For example, it may be used in conjunction with a web re-direction service that maps unique identifiers or other data to web page addresses. It may also be implemented within a local DNS server on the Internet, which maps domain names to IP addresses and returns the IP addresses to client applications, like browsers.

The method may be implemented in software designed to execute on a network client computer, such as part of the operating system or Internet browser on the client. Alternatively, it may be implemented in router application or Domain Name Service software running on a server computer on the Internet, such as in a web re-direction service. In one particular configuration, a reader application executing on the client extracts a database index from physical or electronic media content and sends it to the router application, which uses the index to look up IP addresses for a URL associated with the index. In this particular configuration, the URL-to-database index associations are specified ahead of time and stored in the database. When the URL is added to the database, the router application obtains all of the IP addresses that are associated with that particular URL from the DNS server and stores them in the database.

To make a connection, the reader application executing on the client sends the index to the router application, which looks up the corresponding URL and returns all of the IP addresses that serve that URL to the client. The reader application then sends a TCP request to each of the IP addresses, ignoring all but the fastest reply. Finally, the reader application updates the operating system's IP-to-domain name database to reflect the fastest IP address along with its domain name or URL. Alternatively, the router application can determine the IP address with the fastest response time for each URL in the database, and return that IP address in response to the client's request. Preferably, the URL should be retained with the IP address because some web servers need both to map the URL to a particular network resource being requested, such as a web page or other data.

Further features of the invention will become apparent from the following detailed description and accompanying drawings.

### BRIEF DESCRIPTION OF THE DRAWINGS

FIG. 1 is a diagram illustrating an overview of a domain name resolver process.

FIG. 2 is a diagram showing how a domain name resolver intercepts a request to map a domain name to an IP address.

FIG. 3 is a diagram showing how the domain name resolver issues a request for all IP addresses for the domain name.

FIG. 4 is a diagram showing how the domain name resolver gets one or more IP addresses from the DNS server.

FIG. 5 is a diagram showing how the domain name resolver determines the IP address with the fastest response time for the case where the domain name has multiple associated IP addresses.

FIG. 6 is a diagram showing how the domain name resolver returns one or more preferred IP addresses with the fastest response times to the client application.

FIG. 7 is a diagram showing how the client makes a connection request using the preferred IP address for a given domain name.

FIG. 8 is a diagram illustrating an operating environment for the name resolver illustrated in FIGS. 2-7.

### DETAILED DESCRIPTION

While this invention may be implemented in many different forms, the drawings show specific implementations, which are only example and are not intended to limit the scope of the invention to the illustrated embodiments.

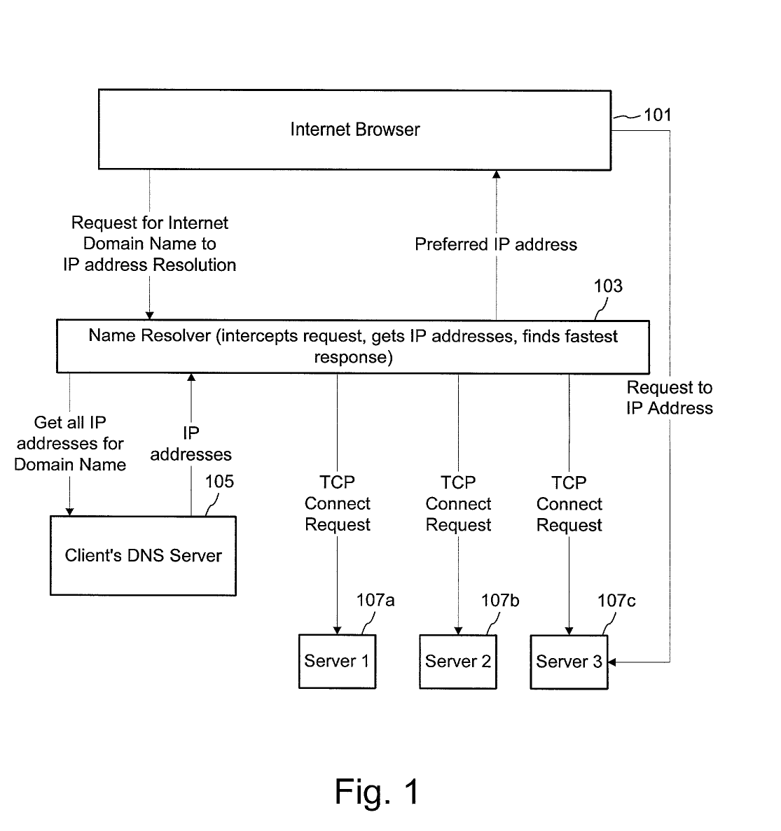

FIG. 1 is a diagram illustrating an overview of an implementation of the invention. As shown in FIG. 1, a client application such as a browser program 101 (e.g., Internet browser) seeks to establish a network connection with a network resource via the resource's domain name. A name resolver program 103 intercepts a request from the browser to a DNS server 105 to translate the domain name to an IP address. It then queries servers 107a-c at the IP addresses for that domain name and returns the preferred IP address or addresses to the browser.

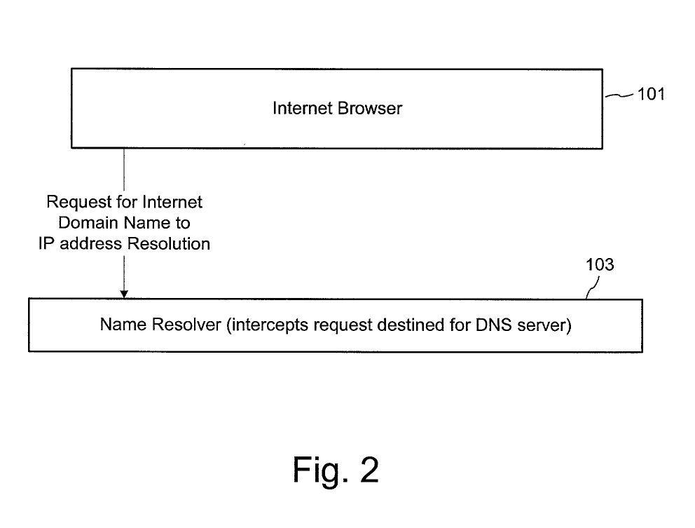

FIGS. 2-7 illustrate how the system in FIG. 1 operates. As shown in FIG. 2, the process begins when the browser makes a request to translate a domain name to an IP address. Specifically, the browser sends a DNS query to a DNS server, which includes a host name and an indication that an IP address is requested. The name resolver 103, intercepts the DNS query request.

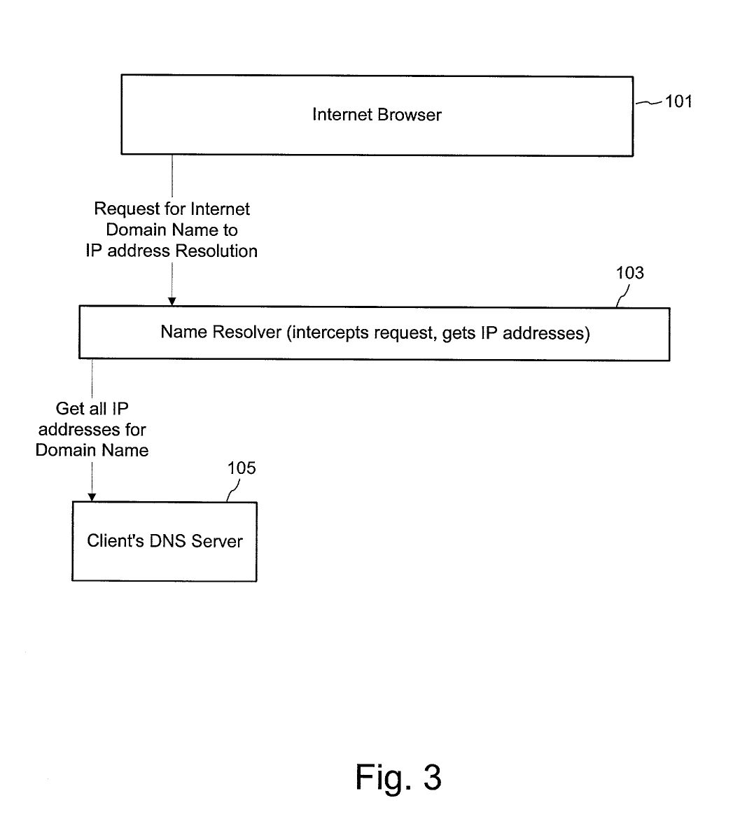

As shown in FIG. 3, the name resolver 103 sends to a DNS server 105 the DNS query, which includes a host name and an indication that an IP address is requested.

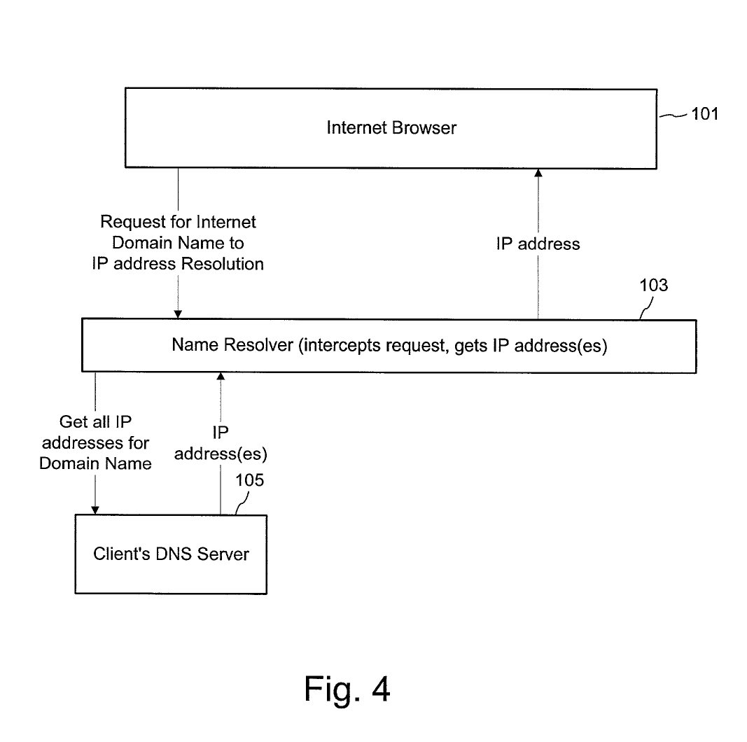

As shown in FIG. 4, the DNS server 105 returns one or more IP addresses associated with the host name to the name resolver 103. If there is only one IP address, the name resolver 103 returns the IP address to the browser program 101, or alternatively, to the IP-to-name cache managed by the operating system in the client computer. This is a cache that stores mappings between domain names and corresponding IP addresses. Typically, the cache manager is programmed to store some number of most recently used or most frequently used domain names.

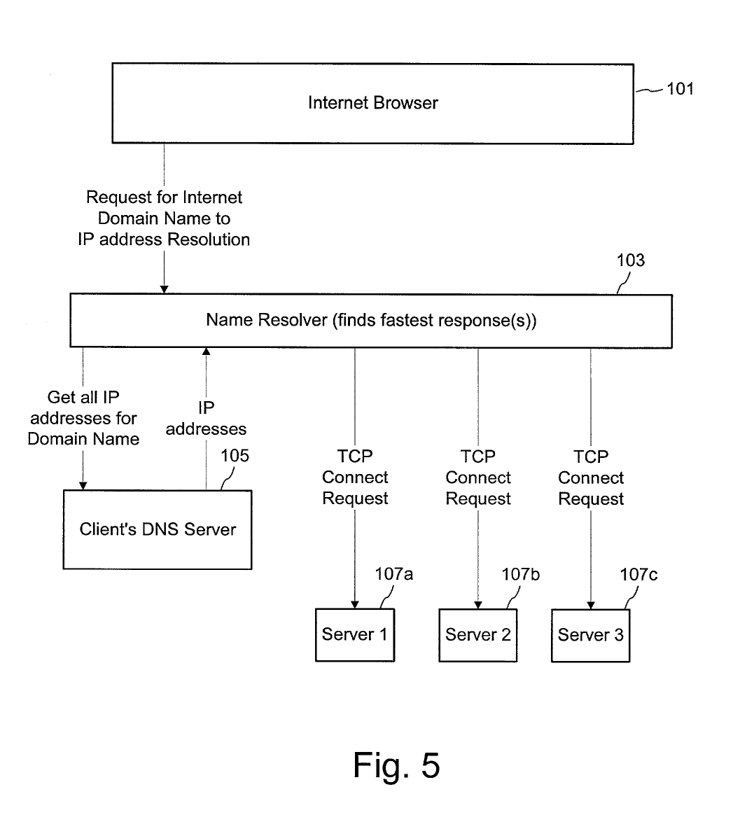

As shown in FIG. 5, if the DNS server returns more than one IP address, then the name resolver 103 sends one TCP connection request packet to the server (e.g., 107a-c) at each IP address.

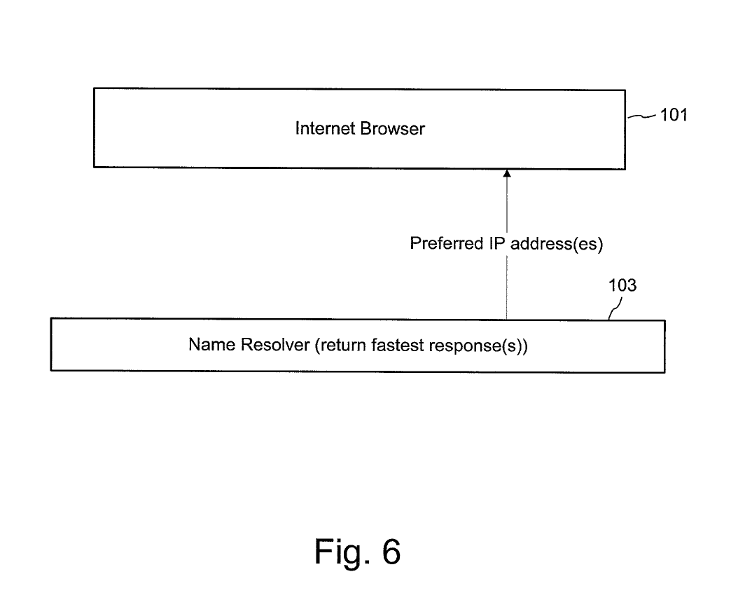

As shown in FIG. 6, the name resolver determines which server responds fastest and then returns the IP address of that server 107 to the browser, or alternatively, to the IP-to-name cache in the client.

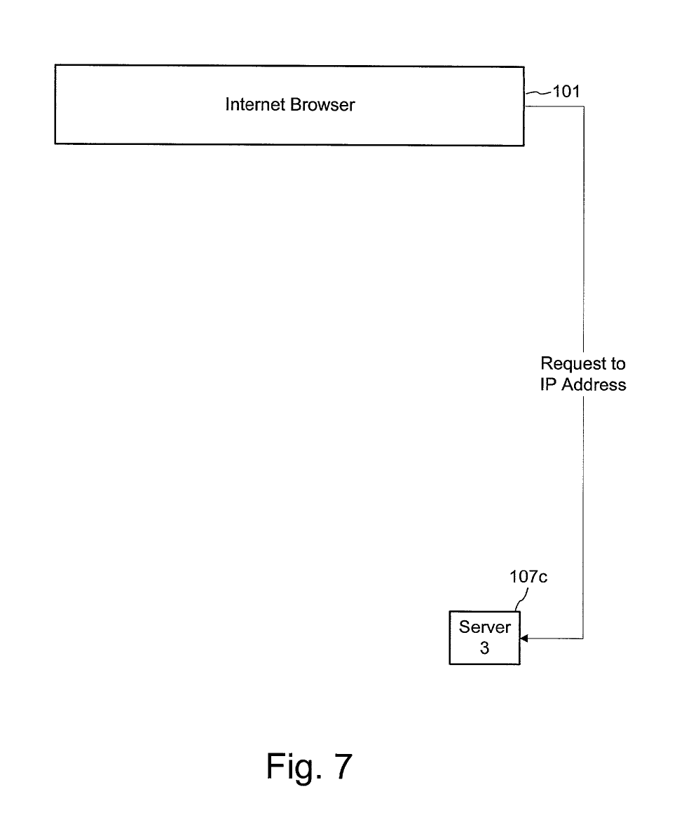

As shown in FIG. 7, the browser uses the IP address returned for the domain name to fetch information associated with the domain name, such as a web page. The programmatic functions of the name resolver shown in FIGS. 2-7 can be implemented in the client, such as integrated into the operating system or an application program, such as an Internet browser program.

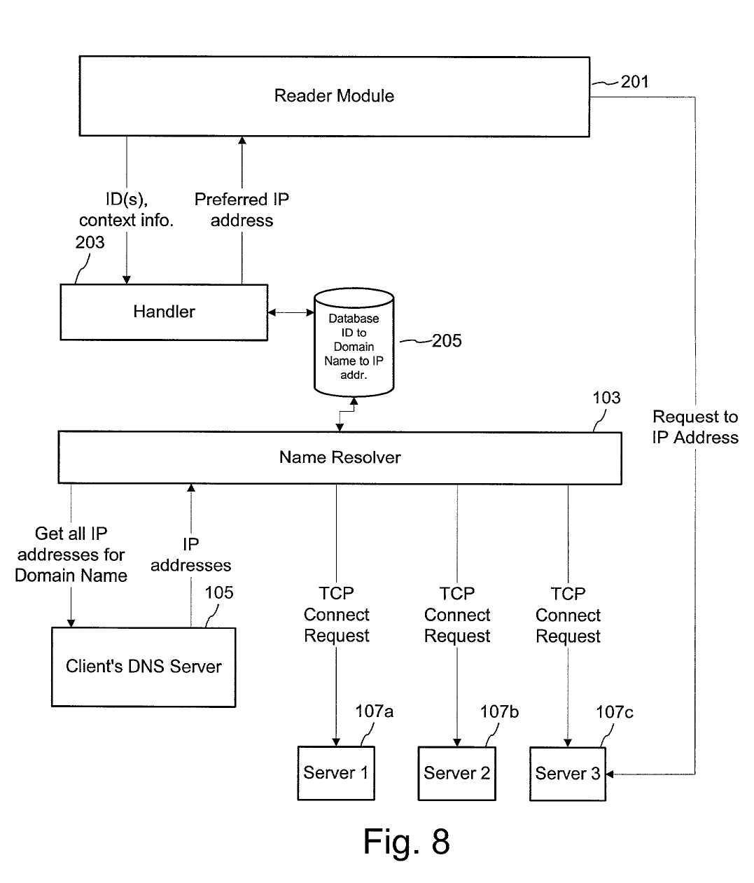

Alternatively, the name resolver can be implemented in a server, which client applications communicate with to get preferred IP addresses for domain names. In one implementation, for example, the domain name resolver is part of an Internet redirection system. FIG. 8 shows an example of such a system. In this example, a reader module 201 executing on the client computer connects the client to a web page based on an identifier extracted from a physical or electronic media object.

The reader module is software or firmware implemented as a stand alone application or integrated into another program, such as an operating system, Internet browser, etc. (e.g., the module may be a DLL or other software object incorporated into another executable program). The module operates in conjunction with reader hardware or other input devices to get an identifier that references a web page or other Internet resource. Examples of these devices include a video camera for capturing digital images of digitally watermarked objects (objects with substantially imperceptible digital watermarks embedded in a printed image or surface texture), a bar code scanner for scanning a bar code, an RFID tag reader, a smart card reader, a magnetic stripe reader, etc. Alternatively, software in the client operates directly on electronic signals (as opposed to electronic signals derived from physical objects), such as images, audio or video to extract an identifier carried in a digital watermark, file header, metadata, etc. in the electronic content. For examples of systems for extracting such identifiers from electronic or physical objects, see U.S. Pat. No. 6,122,403 and U.S. patent application Ser. Nos. 09/571,422, 09/597,209, 09/563,664 and 09/864,084. Finally, the user may simply enter the identifier via speech (voice recognition software), keyboard, or myriad of other user input devices and associated software drivers.

As shown in FIG. 8, the reader module forwards the identifier (ID), and possibly other context information, to a handler program 203. In this implementation, the handler executes on a server on the Internet and communicates with the reader module via a TCP/IP connection. Through this connection, the reader sends the ID and context data in an XML packet. The handler program, in turn, uses the ID to look up a preferred IP address or set of available IP addresses from a database 205 that maps IDs to corresponding information or programmatic actions at a particular domain name. The preferred IP address or a set of available IP addresses is returned to the reader application. In either case, the reader preferably updates its domain name to IP address cache with the domain name and corresponding IP addresses. In the former case, the IP address with the fastest reply is determined on the server and returned to the reader. In the latter case, the reader uses the set of corresponding IP addresses returned by the server to check for the fastest reply, and records the one with the fastest reply in the domain name to IP address cache.

The name resolver operates on the domain names in the database and retrieves the preferred IP address or set of IP addresses for each ID. The name resolver may be programmed to periodically update the IP addresses associated with IDs in the database.

In some cases, an IP address is associated with several network resources, each having a unique domain name or URL. For example, in the case of host headers, an IP address may be associated with several different servers, each providing resources at different URLs. As such, it is necessary to store the domain name/URL along with the IP address provided by the domain name resolver. Depending on the implementation, this may include a set of available IP addresses for the domain name/URL or an IP address with the fastest reply for the domain name/URL.

Concluding Remarks

Having described and illustrated the principles of the technology with reference to specific implementations, it will be recognized that the technology can be implemented in many other, different, forms. To provide a comprehensive disclosure without unduly lengthening the specification, applicant incorporates by reference the patent and patent applications referenced above.

The methods, processes, and systems described above may be implemented in hardware, software or a combination of hardware and software. For example, the network communication methods may be implemented in a programmable computer or a special purpose digital circuit, including implementations in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

I claim:

1. A method of Internet domain name resolution comprising:
intercepting a request to map a domain name to an IP address;
retrieving a plurality of available IP addresses associated with the domain name from a DNS server;
determining which of the available IP addresses provides a fastest response time; and
providing the IP address with the fastest response time for use in establishing a TCP/IP connection.

2. A computer readable medium having instructions for performing the method of claim 1.

3. The method of claim 1 wherein determining which of the available IP addresses provides a fastest response time includes sending a TCP connection request packet to each of the available IP addresses and measuring a response time for each of the IP addresses that provides a valid response.

4. The method of claim 1 wherein the request is intercepted from a browser application and the IP address with the fastest response time is returned to a client computer on which the browser application resides.

5. The method of claim 4 wherein the IP address with the fastest response time is returned to an IP to domain name cache on the client.

6. A method of Internet domain name resolution comprising:
fetching a Uniform Resource Locator;
retrieving a plurality of available IP addresses associated with a domain name in the Uniform Resource Locator from a DNS server;
determining which of the available IP addresses provides a fastest response time; and
providing the IP address with the fastest response time for use in establishing a TCP/IP connection.

7. A computer readable medium having instructions for performing the method of claim 6.

8. The method of claim 6 wherein the Uniform Resource Locator is read from a database for mapping identifiers to network resources on a computer network.

9. The method of claim 8 wherein the identifiers are extracted from machine readable codes on physical objects.

10. The method of claim 9 wherein the machine readable codes include a digital watemark embedded in a surface texture or image printed on a physical object.
